(19) United States
(12) Patent Application Publication
(10) Pub. No.: US 2011/0045363 A1
(43) Pub. Date: Feb. 24, 2011

(54) PROCESS AND EQUIPMENT TO SIGNIFICANTLY REDUCE CO2 EMISSIONS FROM DIRECT CARBON FUEL CELLS WITHOUT MATERIALLY INCREASING THE COST OF GENERATING ELECTRICITY

(75) Inventor: Robert B. Polack, New York, NY (US)

Correspondence Address: CALFEE HALTER & GRISWOLD, LLP, 800 SUPERIOR AVENUE, SUITE 1400, CLEVELAND, OH, 44114, US

(73) Assignee: Contained Energy, Inc., Shaker Heights, OH (US)

(21) Appl. No.: 12/438,575

(22) PCT Filed: Jul. 27, 2007
(86) PCT No.: PCT/US07/16934

§ 371 Date: Feb. 24, 2009

Related U.S. Application Data
(60) Provisional application No. 60/841,338, filed on Aug. 31, 2006.

(51) Int. Cl. H01M 8/20; F25J 1/00

(52) U.S. Cl. 429/408; 429/101; 62/602

(57) ABSTRACT

A carbon-based energy system including an apparatus for generating electricity and byproduct CO₂, a photosynthesis bioreactor that converts CO₂, and a CO₂ storage unit. In one embodiment, the energy system includes a direct carbon fuel cell (DCFC), a photosynthetic bioreactor, and a thermoacoustic cooler. Also provided is a method for reducing CO₂ emission in energy systems achieved by coupling a photosynthetic bioreactor and a CO₂ storage system with an energy system wherein the CO₂ produced by the energy system is converted to biomass during light hours and is stored during dark hours.

### CROSS-REFERENCE TO RELATED APPLICATIONS

This application claims priority to, and any other benefit of, U.S. Provisional Patent Application No. 60/841,338 filed Aug. 31, 2006, the entirety of which is incorporated herein, by reference.

### BACKGROUND OF THE INVENTION

In today's unsettled energy market there is a continuing search for environmentally friendly technologies which will produce inexpensive electricity from low cost, readily available, strategically secure fuel supplies. Today's coal-based central power plants only achieve electrical efficiency of 35% to 40%, while producing a great deal of environmental damage unless they are retrofitted with complex, expensive pollution control equipment. Since these coal-fired power plants now generate more than 50% of the electricity in the U.S., many people have come to believe that “coal” is by its very nature a “dirty fuel”.

Fossil-based power electrical production facilities generate CO₂, which is a greenhouse gas. Since the industrial revolution the concentration of CO₂ in the atmosphere has been on the rise. However, in the past few decades, with the growth of industrialization throughout the world, this trend has accelerated possibly with serious consequences for weather change and global warming. In an effort to halt the CO₂ build-up the Kyoto Protocol proposed that industrialized countries collectively reduce their production of greenhouse gases emissions by 5.2% compared to the level in 1990. What this means is that to attain this goal by 2010 CO₂ emission would have to be cut by 29% compared to the projected trend line without the Kyoto Protocol target.

The currently accepted wisdom is to either to move to a hydrogen economy and/or sequestration (i.e. bury underground for an indefinite period of time) all the CO₂ produced. Neither of these seems like a very good solution. Hydrogen is not a primary source of energy. It is a method for storing energy. Thus, hydrogen must be produced, which given the current state of development requires a lot of energy and produces a great deal of CO₂So, this does not seem like a winning strategy at least until a better technology is available.

CO₂ sequestration doesn't seem trouble free either. Here the problems include: (1) Sequestration is expensive. As a rule of thumb it is expected to add about 35% to the cost of electricity. Without any obvious economic payback the price of electricity will have to go up. And since advanced economies rely on inexpensive energy this could prove to be a real problem; (2) It is “location dependent” since it requires subterranean cavities close at hand to park the CO₂; (3) It is “size dependent” since it is only economically viable for very large power stations. Otherwise it would be almost impossible to justify the addition cost of infrastructure; and (4) It is difficult to tell what will happen over many years as more and more CO₂ is deposited in these underground “holding depots”.

All this would result in higher cost energy and more investment in transmission and distribution facilities as electricity production is concentrated in a small number of very large production sites. Accordingly, a need exists for better means for controlling CO₂ emission. We believe that a better way does exist and while it may not be a complete solution it does has the potential to greatly improve the CO₂ emission control situation without dramatically increasing the cost of energy.

### SUMMARY OF THE INVENTION

Provided herein are processes and equipment to reduce CO₂ emissions while producing electricity with carbon-based fuels. Described herein is an energy system including an apparatus for generating electricity, a photosynthesis bioreactor for converting the CO₂ produced during the generation of electricity into biomass during light times, and a CO₂ storage unit to store CO₂ during dark times when the photosynthesis bioreactor is not active. In another embodiment, the energy system includes a direct carbon fuel cell (DCFC) and a photosynthesis bioreactor.

Also provided are methods for reducing CO₂ emission in energy systems including coupling a photosynthetic bioreactor and a CO₂ storage system with an energy system wherein the CO₂ produced by the energy system is converted to biomass during light hours and is stored during dark hours.

### DETAILED DESCRIPTION OF THE INVENTION

In today's unsettled energy market there is a continuing search for environmentally friendly technologies which will produce inexpensive electricity from low cost, readily available, strategically secure fuel supplies. We believe that Direct Carbon Fuel Cells (DCFC), such as that developed at the Lawrence Livermore Laboratory (LLNL) (more fully described in various published patents, patents pending and related articles), is one such advanced technology. This is clearly evident from reports that indicate that DCFCs, using a wide range of domestically available carbon-based fuels have been able to achieve electrical efficiency of about 80% (i.e. 80% of the fuel's HHV is converted into electricity), and produce little environmental pollution (no NOx, particulate matter, etc).

These result are quite different from those of today's coal-based central power plants, which only achieve electrical efficiency of 35% to 40%, while producing a great deal of environmental damage unless they are retrofitted with complex, expensive pollution control equipment. Since these coal-fired power plants now generate more than 50% of the electricity in the U.S., many people have come to believe that “coal” is by its very nature a “dirty fuel”.

DCFC could be a major factor in changing the popular attitude that coal, by its nature is a “dirty fuel”. And this is very important since coal is the most abundant fuel not only this country but throughout much of the world.

It should be noted that DCFCs like all fossil-based power electrical production facilities generate CO₂, which is a greenhouse gas. It is interesting to note that if DCFC systems could replace all of the existing coal fired power plants the CO₂ generated by this sector of the economy would decline by more than 50%. Clearly that is far more than the 29% 2010 targets set at Kyoto. But DCFCs would still produce CO₂-albeit at a far lower rate. And for many that is unsatisfactory. Thus the question: What can be done about it?

The approach described herein couples an energy-generating system with a photosynthesis bioreactor, which would convert most, if not all, of the CO₂ into biomass, and a thermoacoustic cooler that would permit temporarily storage of CO₂. In a preferred embodiment, the system includes (1) a Direct Carbon Fuel Cell (DCFC) system which generates electricity and byproduct CO₂; (2) a photosynthesis reactor, which reduces CO₂ emissions during the light periods, such as during daylight or in artificial lighting conditions; and (3) a thermoacoustic cooler, powered by waste heat, which stores CO₂ during the dark periods when photosynthesis does not occur. However, it should be noted that while a specific system has been described in some detail it not the only one that is possible. Therefore, it should be understood that the system will work with some other substitute subsystems—though probably at lower overall efficiency.

In one embodiment, the energy-generating system is a direct carbon fuel cell (DCFC), however, it is noted that this approach may be used with other energy systems that produce CO₂. In other embodiments, the energy-generating system may include, but is not limited to, natural gas fired power stations, coal fired power stations, turbine-generator facilities, syngas production units, and steam reformer H₂ production plants. Because of its high electrical efficiency, DCFCs are preferred. In other embodiments, the energy system may include only a DCFC and a photosynthesis bioreactor.

The photosynthesis reactor, which contains rapidly multiplying algae (with doubling rates on the order of a few hours), would permit the reaction of the CO₂ from the DCFC system with the N₂ from the air in the presence of light to produce biomass that could be further processed into biofuel, chemical feedstock, etc.

The thermoacoustic cooler would utilize waste heat from the DCFC system to take maximum advantage of the energy input and further reduce the CO₂ otherwise vented by the system. The refrigeration system utilized may be any suitable refrigeration system. Some exemplary refrigeration systems include, but are not limited to thermoacoustic coolers, metal hydride refrigerators, absorption refrigerators, zeolite refrigerators, and vapor compression refrigerators. In a preferred embodiment, the refrigeration system is a thermoacoustic refrigerator.

### EXAMPLES

In order to indicate how such a system might work consider the following example:

Assume that at the heart of the system there is a 10 kW DCFC unit operating continually at its “nameplate” rated capacity. The daily input and output of energy and materials would be:

TABLE 1

| | Input | Output |
|---|---|---|
| Carbon | 33 kg | |
| Electricity | | 240 kWh |
| Waste Heat @ 700° C. | 60 kWh | |
| CO₂ | | 121 kg |

Further assume that the bioreactor permits a photosynthesis reaction to occur between CO₂ from the DCFC system and N₂ from the air to form biomass but only when light is available. Clearly light is not available during the entire 24 hours of the day. Thus, for the purpose of this example we will assume a 12 hour light/dark cycle each day. This means that in order to handle the entire day's output in 12 hours the reactor would have to be “oversized”. There may be a number of other possibilities that would not require oversizing the bioreactor including for example: (1) artificial light that might be available for part of the dark time of the day (e.g. lighting in shopping center or hospital) or (2) other use(s) might be found for some of the gaseous CO₂. However, while these possibilities are credible, they will not be discussed further in this application.

It should also be understood that the speed of the reaction and the characteristics of the biomass will depend on the type of algae that will be used.

Assuming that all the CO₂ produced by the DCFC during the course of a 24 hour day is utilized input to the photosynthetic bioreactor for the production of biomass, during that period of time, the energy and material balance would be:

TABLE 2

| | Input | Output |
|---|---|---|
| CO₂ | 121 kg | |
| Air (80% N₂) | 151 kg | |
| Sunlight | Energy | |
| Dry Biomass^{#}* | | 242 kg |

^{#}Biomass yield is based on 1/1 CO₂/N₂ Ratio and 80% N₂ in air.
*Depending on the type of algae used the product may a have high or low lipid content that can be processed for biofuel and/or other organic materials.

The flow of material and the use of the thermoacoustic cooler will be different during the Light and Dark periods of operation. However, in this example, during both time periods the waste heat from the DCFC would be used to provide the energy needed to power the thermoacoustic cooler. Specifically, during the entire 24 hour day the 700° C. CO₂ gas with 60 kWh/day of waste heat will supply about 30 kWh/day of its energy to the thermoacoustic cooler which will produce about 10 kWh/day of cooling capacity. The CO₂ will then exit at 350° C. with its remaining 30 kWh/day of energy.

In order to better understand the operations of this system, it is necessary to consider how the CO₂ would be used during the Light Period of the operation. As noted above the gas would first pass through the thermoacoustic cooler and exit at about 350° C. This exiting gas would then be used to dry the biomass produced by the photosynthesis bioreactor, and then preheat the “new” air that will be used in the DCFC. It should be noted that the “used air” exiting from the DCFC could also be used to preheat the “new air” entering the DCFC. At this point, the 60 kg of now cooled CO₂ produced during Light Period, because of its use as a source of heat in the various heat exchangers operations mentioned above, would be significantly cooler, and would then be mixed with about 76 kg of ambient air. The resultant mixture, if necessary, would have to be at brought to the proper temperature (estimated to be about 60° to 70° C.) that would permit the algae to realize its optimal doubling rate and best chemical composition.

In some embodiments, the thermoacoustic cooler might be needed to make a final temperature adjustment, however, in this example, because of finely tuned heat exchange steps, that is not considered to be necessary. Therefore, all of the Light Period thermoacoustic cooling capacity (5 kWh) is assumed to be available for other purposes. While such an exquisite energy balance is highly desirable, it is not critical to the invention itself.

During the 12 hour Dark Period the photosynthesis reaction cannot occur. But just as during the previous 12 hour Light period CO₂ will be produced and waste heat will be used to power the thermoacoustic cooler. Here again the remaining energy in the 350° C. CO₂ gas exiting from the thermoacoustic cooler would be used to preheat the DCFC “new air” input, dry some of the biomass produced during the prior Light Period, as well as for any other heat transfer operations that may be required. The precooled CO₂ would then be refrigerated to −78° C., at which temperature it could be stored as dry ice temperature.

It is anticipated that the thermoacoustic cooler will be able to generate about 5 kWh of cooling capacity during a 12 hour period. Since it takes about 0.18 kWh/kg (based on specific heat of 2.36×10⁻⁴ kWh/kg/° C. and latent heat of vaporization 0.16 kWh/kg) to convert 200° C. CO₂ to dry ice temperature, this amount of cooling capacity would be able to produce about 27 kg dry ice (or about 45% of the total) during the Dark period. That would leave the system with about 33 kg of gaseous CO₂ produced during the Dark Period and 5 kWh of cooling capacity produced during the Light Period. Assuming that we can time shift the 5 kWh to the Dark Period (i.e. trade the daytime A/C capacity for an equivalent amount nighttime A/C) we could convert another 27 kg of CO₂ to dry ice. That would only leave 6 kg/day of CO₂ that would have to be vented—making this an essentially Zero Emission system.

It should be noted that because of the system's high electrical efficiency there is a limited amount of waste energy available to power the thermoacoustic cooler. In the above example this limitation was the closest thing to a process bottleneck. However, there is nothing special about the DCFC waste heat. Therefore, any locally available high temperature waste heat stream (e.g. turbine generator, diesel, etc) would be a suitable source of energy to power the thermoacoustic cooler. But as a rule it would be necessary to segregate the supplemental waste heat from the hot CO₂ gas stream.

Since the density of solid CO₂ is 1600 kg/m³ a night's production (if tightly packed) would fit into a 0.017 m³ container (or a cube 26 cm on the side). Assuming we could time shift the rest of the cooling capacity, the 54 kg of dry ice that would be produced would require about 0.034 m³ of storage capacity (52 cm on the side).

At the appropriate time, the dry ice could be defrosted and used as feedstock for the photosynthesis reactor, or if necessary sold as such.

In summary, if all the CO₂ and cooling capacity is time-matched, and the logistic are set-up so that the system only needs to be refueled every 10 days the net input and output on both a daily and 10 day basis would be as follows:

TABLE 3

| | |
|---|---|
| Per Day | 10 Day Period |

| | Input | Output | Input | Output |
|---|---|---|---|---|
| Carbon (kg) | 33 | | 330 | |
| Electricity (kWh) | | 240 | | 2400 |
| Dry Biomass | | 460 | | 4600 |
| Vented CO₂^{X} (kg) | | 6 | | 60 |

^{X}During Dark Period

For all intents and purposes this would be a Zero CO₂ Emission system. What is even more striking is that this would be accomplished without materially degrading DCFC's excellent electrical efficiency or cost profile. Considering the small size of this system described in this example it probably would be impractical to process the biomass on site. Therefore, the dried biomass from this and other relatively small DCFC system sites might be shipped to a biorefinery where it would be processed into biofuels, chemical feed stocks and other products. It is anticipated that the delivery of carbon fuel and the removal of the biomass could be made part of one operation which would take place every 10 days.

While the examples include in this disclosure have been set forth to describe the general approach of this invention that are related to a specific situation they are not intended to limit the invention to specifications described herein. Modifications and changes will become apparent to those skilled in the art, but that should not limit in any way the general nature of the invention.

1-15. (canceled)

16. An energy system comprising a direct carbon fuel cell (DCFC), a photosynthesis bioreactor and a thermoacoustic cooler,
wherein the DCFC generates electricity and byproduct CO₂,
the thermoacoustic cooler cools the byproduct CO₂ and is powered at least in part by waste heat generated from the DCFC, and
the photosynthesis bioreactor uses the byproduct CO₂ to convert said byproduct CO₂ to biomass.

17. The energy system of claim 16, wherein the energy system further comprises a first heat exchange system, and the byproduct CO₂ is moved through said first heat exchange system to pre-heat new air supplied to the DCFC.

18. The energy system of claim 16, wherein the energy system further comprises a second heat exchange system, and the byproduct CO₂ is moved through said second heat exchange system to dry the biomass.

19. The energy system of claim 16, wherein the thermoacoustic cooler refrigerates the byproduct CO₂ to produce dry ice.

20. The energy system of claim 19, wherein the dry ice is stored during a dark period.

21. The energy system of claim 19, wherein the dry ice is defrosted and used as feedstock for the photosynthesis bioreactor during a light period.

22. The energy system of claim 16, wherein the thermoacoustic cooler is further powered by a supplemental waste heat stream from a source other than the DCFC.

23. The energy system of claim 16, wherein the energy system reuses at least 50% of the byproduct CO₂ generated by the DCFC.

24. The energy system of claim 16, wherein the energy system reuses at least 80% of the byproduct CO₂ generated by the DCFC.

25. A method for reducing CO₂ gas emission produced by a direct carbon fuel cell (DCFC), the method comprising,
routing hot CO₂ gas produced by the DCFC through a thermoacoustic cooler to produce cooled CO₂ gas;
routing the cooled CO₂ gas through a photosynthesis bioreactor to produce biomass during a light period; and
further cooling the cooled CO₂ gas in the thermoacoustic cooler to produce dry ice for storage during a dark period.

26. The method of claim 25, further comprising passing the cooled CO₂ gas though a first heat exchange system to pre-heat new air supplied to the DCFC.

27. The method of claim 25, further comprising passing the cooled CO₂ gas through a second heat exchange system to dry the produced biomass.

28. The method of claim 25, wherein the dry ice is defrosted and used as feedstock for the photosynthesis bioreactor during a light period.

29. The method of claim 25, wherein the thermoacoustic cooler is powered at least in part by waste heat generated from the DCFC.

30. The method of claim 29, wherein the thermoacoustic cooler is further powered by a supplemental waste heat stream from a source other than the DCFC.

31. The method of claim 25, wherein the method reduces CO₂ gas emission produced by the DCFC by at least 50%.

32. The method of claim 25, wherein the method reduces CO₂ gas emission produced by the DCFC by at least 80%.

33. An energy system comprising a direct carbon fuel cell (DCFC), a photosynthesis bioreactor, a thermoacoustic cooler, and a first and second heat exchange system,
wherein the thermoacoustic cooler cools CO₂ generated by the DCFC;
wherein the cooled CO₂ is moved through the first heat exchange system to provide further cooled CO₂;
wherein during a light period, the further cooled CO₂ is moved to the photosynthesis bioreactor to produce biomass and moved through the second heat exchange system to dry said biomass; and
wherein during a dark period, the further cooled CO₂ is refrigerated in the thermoacoustic cooler to form dry ice.

34. The energy system of claim 32, wherein the energy system reuses at least 50% of the CO₂ generated by the DCFC.

35. The energy system of claim 32, wherein the energy system reuses at least 80% of the CO₂ generated by the DCFC.
